(19) United States
(12) Patent Application Publication
(10) Pub. No.: US 2026/0361057 A1
(43) Pub. Date: Nov. 12, 2026

(54) Externally Retrofitted Remote-Controlled Recloser Module with Integrated Environmental Sensing and AI Response

(71) Applicant: Steven Quinn McCain, Littlefield, TX (US)

(72) Inventor: Steven Quinn McCain, Littlefield, TX (US)

(21) Appl. No.: 19/651,481

(22) Filed: Apr. 17, 2026

Related U.S. Application Data
(60) Provisional application No. 63/791,240, filed on Apr. 18, 2025.

(51) Int. Cl. H02B 1/015; G08C 17/02; H01H 47/22; H02J 13/12

(52) U.S. Cl. CPC H02B 1/015; G08C 17/02; H01H 47/22; H02J 13/12

(57) ABSTRACT

An externally mountable retrofit apparatus for remotely controlling an existing manually-operated electrical recloser. The apparatus comprises a two-piece mounting assembly that attaches to a recloser hanger, recloser body, mounting bracket, cross-arm hardware, or other structural support without disassembly of the recloser housing; an actuator assembly coupled via linkage to the external switch handle preserving manual operability; a sensor suite measuring wind speed, humidity, and temperature; an acoustic sensor continuously monitoring in a low-power sleep state for fault signatures including electrical arcing; and a processor executing configurable control logic for automated actuation based on sensor thresholds, remote commands, or regulatory compliance settings. A standalone solar-charged power system provides extended autonomous operation. A wireless module supports local and cellular communication. Multiple units coordinate three-phase switching with minimal latency. An adaptive fault classification algorithm correlates multi-sensor data, updateable remotely. Security is maintained via rolling code authentication.

### CROSS-REFERENCE TO RELATED APPLICATIONS

This application claims priority to U.S. Provisional Patent Application No. 63/791,240, filed Apr. 18, 2025, entitled “Externally Retrofitted Remote-Controlled Recloser Module with Integrated Environmental Sensing and AI Response,” the entire disclosure of which is incorporated herein by reference in its entirety.

### FIELD OF THE INVENTION

The present invention relates generally to electrical power distribution systems. More specifically, it relates to devices and methods for retrofitting existing manually-operated electrical reclosers for remote and automated control, particularly for applications involving grid modernization, wildfire mitigation, public safety, and operational efficiency.

### BACKGROUND OF THE INVENTION

Electrical power distribution grids rely on protective devices to ensure reliability and safety. One of the most common devices found on overhead utility poles is the automatic circuit recloser. A recloser is an automatic, high-voltage electric switch designed to detect and interrupt momentary faults, including but not limited to those caused by lightning strikes, falling tree branches, or animal contact. After a short delay, the recloser automatically closes to re-energize the line. If the fault persists, the recloser will open again, repeating this open-close sequence a predetermined number of times before locking out, requiring manual intervention.

A significant portion of the vast installed base of reclosers, particularly in rural or older service territories, are purely mechanical or require direct manual operation by a line crew using a hot stick. This manual operation presents numerous challenges. It is labor-intensive, time-consuming, and costly, as it requires dispatching a crew to the physical location of the device. This process introduces significant delays in power restoration or in de-energizing a line for safety or maintenance. Furthermore, manual operation poses inherent safety risks to utility personnel who must work in close proximity to high-voltage equipment, often in adverse weather conditions.

In recent years, the need for rapid, remote control of power distribution assets has become critically important due to the increasing risk of catastrophic wildfires. Regulatory mandates and utility initiatives such as Public Safety Power Shutoffs (PSPS) require the de-energization of power lines during high-risk weather conditions characterized by high winds and low humidity. The inability to remotely and quickly operate thousands of manual reclosers across a wide geographic area is a major impediment to effective wildfire mitigation. Manually operating these devices is too slow to respond to rapidly changing weather conditions.

Current solutions are often inadequate. The primary option is the complete replacement of the existing manual recloser with a new, fully electronic smart recloser. This approach is prohibitively expensive, with costs often reaching tens of thousands of dollars per unit. Given that a single utility may have tens of thousands of such reclosers, a full-scale replacement program is financially and logistically unfeasible. There is a clear and unmet need for a cost-effective, non-invasive retrofit solution that can add modern remote control, sensing, and automation capabilities to the existing installed base of manual reclosers without requiring their costly replacement or disassembly.

### BRIEF SUMMARY OF THE INVENTION

The present invention provides a novel apparatus and method for retrofitting existing manually-operated electrical reclosers to enable remote and automated control. The invention, referred to herein as the Externally Retrofitted Remote-Controlled Recloser Module with Integrated Environmental Sensing and AI Response (READI), addresses the limitations of the prior art by providing a non-invasive, standalone, and intelligent solution that can be quickly installed on legacy equipment.

In one aspect, the invention provides an externally mountable retrofit apparatus comprising: a two-piece mounting assembly (110) configured to attach to an existing recloser (10) or its associated mounting infrastructure without requiring disassembly of the recloser housing; at least one actuator assembly (200) mechanically coupled to the external switch handle (20) of the recloser via linkage (202); a wireless communication module (306); a sensor suite (308) comprising at least one environmental sensor; an acoustic sensor (316) configured to monitor ambient sound in a low-power sleep state; and a processor (302) executing control logic for automated actuation. As used herein, “associated mounting infrastructure” includes any structural member used to support or position the recloser in the field, including without limitation a recloser hanger (12), a recloser body, a recloser mounting bracket, cross-arm hardware, the frame of the recloser assembly itself, or any equivalent support structure. The mounting assembly is universally adjustable to accommodate single-phase and three-phase reclosers of varying sizes, configurations, and mounting hardware types.

In another aspect, the invention provides a method of retrofitting an existing manually-operated electrical recloser, comprising attaching the mounting assembly (110) to the existing recloser (10) or its associated mounting infrastructure without disassembling the recloser housing, mechanically coupling the actuator assembly (200) to the external switch handle (20) via linkage (202), configuring sensor thresholds and control logic, and automatically actuating the recloser based on sensor data, remote commands, or acoustic fault detection.

In a further aspect, the mounting assembly (110) comprises adjustable bracketing, bolting, and retention components configured to interface with recloser handles and mounting structures of varying physical configurations adapted to a range of installation contexts. The retention components provide supplemental attachment force that accommodates a range of handle geometries and materials. In another embodiment, the mounting assembly (110) attaches to the structural frame or body of a standalone three-phase recloser assembly via adjustable bracketing, without requiring a dedicated recloser hanger.

The system supports three-phase coordination wherein multiple retrofit apparatus units installed on a three-phase line communicate to perform coordinated switching operations with minimal latency. The apparatus is powered by a standalone solar-charged battery system (500), comprising solar panel (502), battery (504), charge controller (506), and power management unit (508), requires no electrical connection to existing infrastructure, and employs rolling code authentication for secure access. The control logic may operate on-device, in the cloud, or in a hybrid edge-cloud architecture, wherein time-critical actuation rules execute locally at the apparatus without requiring network connectivity, while complex analysis and parameter updates are performed remotely and pushed to the apparatus via the wireless communication module (306).

In a further aspect, the apparatus optionally comprises a location-determination capability configured to associate the apparatus with a geographic position. In one embodiment, the geographic position is provided by a GPS module integrated into the apparatus. In another embodiment, the geographic position is a software-assigned coordinate entered by an authorized operator, optionally derived from a third-party geographic information system. The location capability enables asset tracking and location-based automation rules without requiring GPS hardware in all configurations.

In a further aspect, the apparatus optionally comprises, as an enhanced-tier feature, a non-contact current sensor configured to measure AC load current flowing through the existing recloser. Current data may be analyzed by the processor (302) to detect overloads, fault signatures, abnormal operational states, line loss conditions, and parasitic load conditions. This capability is not required in base configurations of the apparatus.

### BRIEF DESCRIPTION OF THE DRAWINGS

To enable a better understanding of the invention, reference will be made to the accompanying drawings, in which:

FIG. 1 is a system overview diagram illustrating the READI retrofit module (100) installed on a utility pole with an existing recloser (10) supported by a hanger (12). The two-piece mounting assembly (110) comprising mounting pieces (112, 114) secured by fasteners (116) attaches to the hanger (12). The actuator assembly (200) is coupled to the recloser handle (20) via linkage (202). A solar panel (502) is associated with the apparatus and positioned to harvest solar energy.

FIG. 2 is a schematic block diagram showing the existing recloser (10) with external switch handle (20) coupled to the actuator assembly (200) via linkage (202), and illustrating the module housing (100) containing the processor, memory, wireless module, sensor suite, and power system, with the manual hot-stick override path preserved.

FIG. 3 is an internal architecture block diagram of the READI module (100), showing the processor (302) and memory (304) in communication with the wireless communication module (306), the sensor suite (308) comprising wind speed sensor (310), humidity sensor (312), temperature sensor (314), and acoustic sensor (316) operating in a persistent low-power state, the actuator assembly (200), and the power system (500).

FIG. 4 illustrates a three-phase coordination configuration in which three modules 402 (Phase A), 404 (Phase B), and 406 (Phase C) are installed on a single utility pole or crossarm structure, each module attached to a respective single-phase recloser. The modules communicate with each other via a local communication link 410, which may be a wired serial bus, a Bluetooth Low Energy (BLE) mesh network, a dedicated sub-gigahertz (sub-GHz) radio link, or another suitable short-range communication protocol. This single-pole installation enables coordinated switching operations among all three phases. The coordination mode is configurable and supports at least two modes: simultaneous trip, in which all three phases are opened concurrently in response to a fault or command, and independent operation, in which each module acts autonomously based on its own sensor data and control logic.

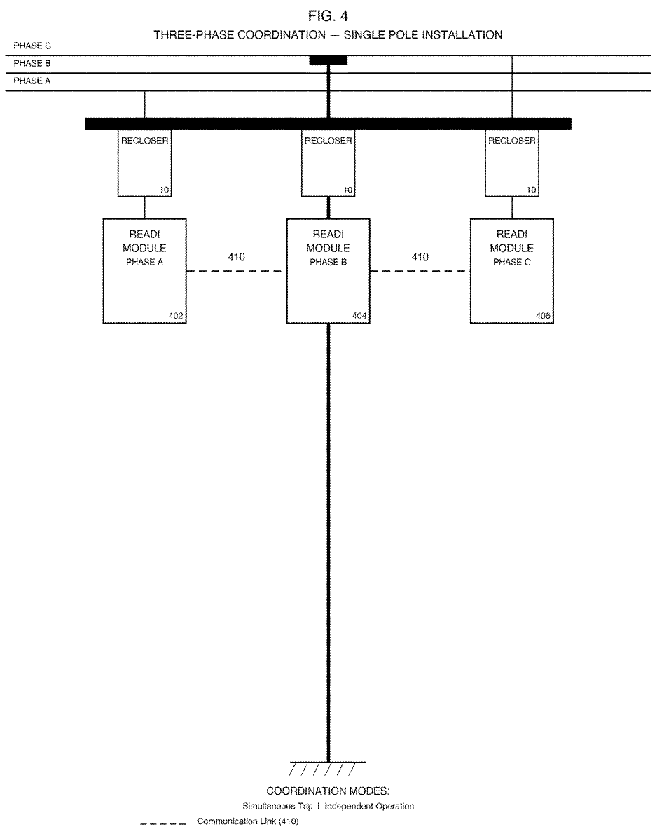

FIG. 5 is a power system architecture diagram showing the solar panel (502) supplying power through a charge controller (506) to a rechargeable battery (504), with a power management unit (508) distributing power to the processor (302), wireless module (306), sensors (308, 316), and actuator assembly (200), providing extended autonomous operation between charge cycles.

FIG. 6 is a graphical user interface diagram illustrating the READI control application (600) displaying wind speed (602), humidity (604), and temperature (606) sensor readings, open (608) and close (610) control buttons, configurable parameter thresholds (612), a wildfire compliance mode selector (614), and a maintenance lockout toggle (616), accessible via the wireless communication module (306).

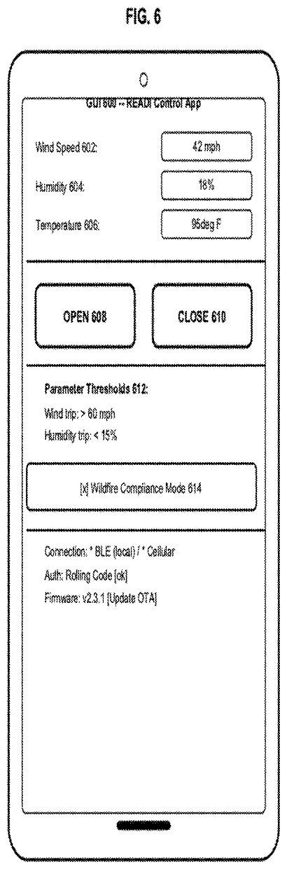

### DETAILED DESCRIPTION OF THE PREFERRED EMBODIMENTS

The following description is of the best-contemplated mode of carrying out the invention. This description is not to be taken in a limiting sense but is made merely for the purpose of illustrating the general principles of the invention. The scope of the invention is best defined by the appended claims.

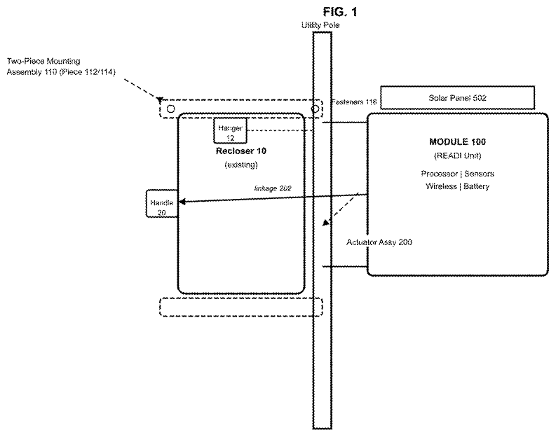

Referring now to FIG. 1, the READI retrofit module 100 is shown installed on a conventional manually-operated electrical recloser 10 mounted on a utility pole via a hanger 12. The module 100 communicates bidirectionally with a cloud or remote system and presents data and controls through a wireless operator interface. The module 100 is compatible with recloser installations utilizing a recloser hanger 12, a mounting bracket, or other structural support member, including standalone three-phase recloser assemblies.

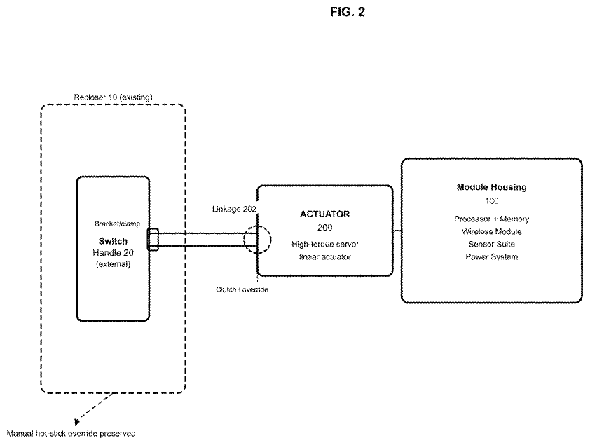

As further shown in FIG. 1 and FIG. 2, the mounting assembly 110 comprises two mounting pieces 112, 114 as its core physical attachment mechanism. In a preferred embodiment for hanger-mount installations, the pieces 112, 114 clamp around the structural frame of the recloser hanger 12 and are secured using fasteners 116, without requiring disassembly of the recloser housing 10. The mounting pieces feature slots or multiple mounting points to accommodate various sizes and configurations of recloser hangers, ensuring universal fit for a wide range of single-phase reclosers. In an alternative embodiment for standalone three-phase recloser installations, the mounting assembly 110 attaches to the structural frame or body of the recloser assembly, or directly to the utility pole or cross-arm via adjustable bracketing, without requiring a dedicated recloser hanger. The assembly may be constructed from stainless steel, powder-coated aluminum, or high-strength UV-stabilized polymer.

In certain embodiments, the mounting assembly 110 further comprises one or more magnetic retention components configured to removably secure secondary monitoring components to a surface of the mounting assembly or recloser housing. Secondary monitoring components include at least one of the acoustic sensor 316, a camera module, and cable management hardware. The magnetic retention components provide tool-free repositioning of secondary monitoring components without requiring permanent modification to the host recloser. The primary actuator assembly 200 employs adjustable mechanical bracketing independent of the magnetic retention components.

As shown in FIG. 2, the actuator assembly 200 is mechanically coupled to the recloser switch handle 20 via linkage 202. The coupling is designed to preserve the original manual operability of the recloser switch handle 20, allowing a lineman to override the module using a hot stick without removing the module 100. The actuator assembly 200 may comprise a high-torque magnetic servo, a linear actuator, or an electromagnetic closing coil. The coupling is non-invasive, using a bracket or clamp attached to the handle.

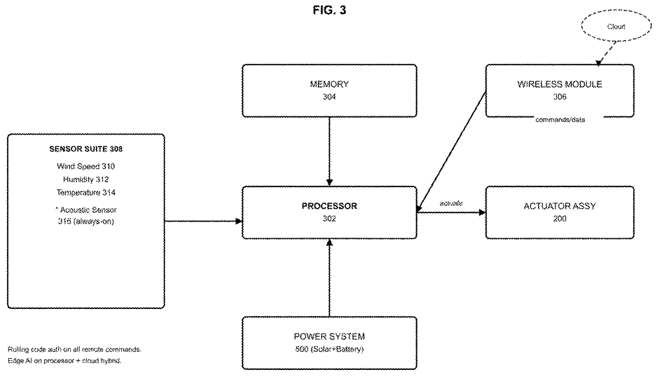

Referring to FIG. 3, the processor 302 executes control logic stored in memory 304 and interfaces with the wireless communication module 306. In a high-tier embodiment, the wireless module 306 provides both cellular communication and Bluetooth Low Energy (BLE) connectivity. A low-tier embodiment provides Bluetooth-only communication for proximity-based field control. In a three-phase coordination embodiment, the wireless communication module 306 further comprises a dedicated wireless communication interface configured to enable direct inter-unit communication between a plurality of apparatus units installed on a common utility pole or support structure, without requiring routing through a central server.

The processor 302 interfaces with the sensor suite 308, which includes: a wind speed sensor 310 (anemometer), a humidity sensor 312 (hygrometer), a temperature sensor 314, and an acoustic sensor 316. The acoustic sensor 316 is configured to continuously monitor ambient sound in a low-power sleep state. It detects specific acoustic signatures associated with power line faults, including electrical arcing, mechanical stress impacts, overcurrent fault events, and acoustic signatures associated with mechanical stress impacts from wildlife or environmental contact. Upon detecting a qualifying fault signature, the acoustic sensor 316 generates an interrupt signal that wakes the processor 302 from a sleep state for fault analysis, recloser actuation, or user notification via the wireless module 306. In certain embodiments, the acoustic sensor 316 operates in a persistent low-power sleep state in which signal processing executes continuously on a dedicated low-power co-processor, without requiring active polling by the processor 302, ensuring low-latency fault detection while maintaining power consumption within the constraints of the self-contained power system 500.

In an enhanced-tier embodiment, the sensor suite 308 further comprises a non-contact current sensor configured to measure AC load current flowing through the existing recloser 10 without direct electrical connection, using inductive or similar non-invasive sensing techniques. Current data from the non-contact current sensor is analyzed by the processor 302 to detect overload conditions, fault current signatures, and abnormal operational states, and may further be used to identify line loss and parasitic load conditions across the distribution circuit. The non-contact current sensor is an optional enhancement and is not required in base configurations of the apparatus.

As illustrated in FIG. 3, the control logic executed by processor 302 evaluates sensor readings against configured thresholds and compliance modes, displayed to operators via the control application 600 showing wind speed (602), humidity (604), and temperature (606) readings, and providing open (608) and close (610) controls. When sensor values meet or exceed configured thresholds (612), or when an acoustic fault signature is detected, the processor 302 actuates the recloser via actuator assembly 200, logs the event to local and remote data stores, and notifies the operator via wireless module 306. Time-critical actuation rules execute on-device for minimal latency without requiring network connectivity; complex analysis, trend detection, and adaptive algorithm updates are performed in the cloud with updated parameters pushed to the device remotely via the wireless module 306. This hybrid edge-cloud architecture provides both low-latency local response and the benefit of remotely-delivered operational improvements.

The processor 302 further executes an adaptive fault classification algorithm configured to distinguish between fault conditions requiring actuation and benign environmental events, based on multi-sensor data correlation including at least the acoustic sensor 316 and the environmental sensors of the sensor suite 308. The adaptive fault classification algorithm is updateable remotely via the wireless communication module 306 to incorporate updated classification parameters derived from field data collected across a plurality of deployed apparatus units, without requiring physical access to the apparatus.

In certain embodiments, sensor data collected from a plurality of deployed apparatus units across a geographic region may be aggregated at a remote server for use in regional environmental monitoring, grid condition analysis, fire risk assessment, weather service integration, or other downstream analytical applications. Such aggregated data represents an additional output of the apparatus beyond direct recloser control and may be made available to third-party data consumers.

A particularly important feature is the wildfire compliance mode (614), a user-configurable set of rules aligned with regulatory requirements and adaptable to local conditions including geographic region, pole environment, and historical weather patterns for Public Safety Power Shutoff (PSPS) events. The mode automatically places the recloser in a non-reclosing state when measured wind speed exceeds a regulatory threshold while relative humidity is simultaneously below a regulatory minimum threshold.

In another embodiment, the module (100) includes a maintenance lockout mode, also referred to as a non-reclosing mode. When activated by an authorized user via the control application (600) or a direct command through the wireless communication module (306), the processor (302) prevents any automatic or remote actuation of the recloser (10) for the duration of a user-initiated lockout period. This mode ensures that the recloser remains de-energized during line maintenance operations, preventing accidental re-energization that could endanger utility personnel working on the line. The maintenance lockout mode can be activated and deactivated remotely, and an active lockout status is displayed on the GUI (600) and transmitted to any connected supervisory system. The lockout remains in effect until explicitly released by an authorized user, even if sensor conditions or remote commands would otherwise trigger recloser actuation.

When multiple modules are installed on a single pole for three-phase coordination, the modules communicate locally via the communication link (410). In simultaneous trip mode, when any one module detects a fault condition or receives a trip command, it broadcasts a trip signal to the other modules on the same structure, and all three phases are opened concurrently. In independent operation mode, each module operates autonomously based on its own sensor inputs and configured thresholds.

The wireless communication module (306) supports communication via at least one of DNP3, IEC 61850, and Modbus protocols, enabling local field control by personnel via a mobile application (600), long-range communication with remote monitoring systems, inter-unit coordination via the wireless link (410), and integration with Supervisory Control and Data Acquisition (SCADA) systems.

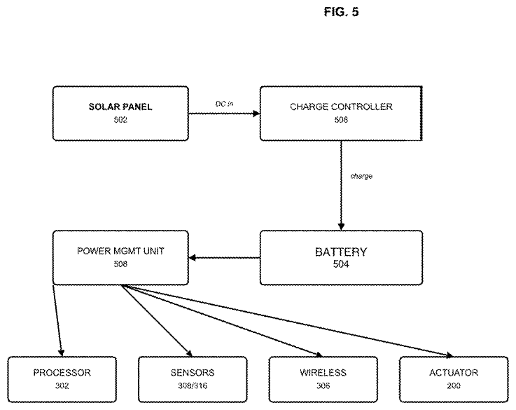

The power system (500) of the module (100), as shown in FIG. 5, comprises a solar panel (502) associated with the apparatus and positioned to harvest solar energy, which supplies power through a charge controller 506 to a rechargeable battery (504). In one embodiment, the battery (504) is a Lithium Iron Phosphate (LiFePO4) battery chosen for its long cycle life and wide operating temperature range. A power management unit 508 regulates distribution of power to the processor 302, wireless module 306, sensors 308, 316, and actuator assembly 200. The system operates primarily in a sleep mode where only the acoustic sensor 316 and environmental sensors are periodically active, providing extended autonomous operation between charge cycles.

Security is maintained through a rolling code authentication protocol for all remote commands. A central server generates time-sensitive, single-use tokens that must be presented to control the device, preventing unauthorized access and replay attacks.

In certain embodiments, the apparatus optionally comprises a location-determination capability configured to associate the apparatus with a geographic position. The geographic position is determinable by a GPS module integrated into the apparatus, by a software-assigned coordinate entered by an authorized operator, or by coordinates derived from a third-party geographic information system. This enables asset tracking and location-based automation rules without requiring GPS hardware in all configurations.

All control parameters, sensor thresholds, compliance mode settings (614), and firmware are, in certain embodiments, remotely reprogrammable via the wireless module 306 after field installation without requiring physical access to the apparatus.

In certain embodiments, the wireless communication module 306 implements robust data encryption protocols including AES or TLS to secure all data transmission between the READI apparatus and remote systems, ensuring confidentiality and integrity of sensor readings, control commands, and diagnostic information.

In certain embodiments, the apparatus comprises a data logging module configured to store in non-volatile memory 304 at least historical sensor data, recloser actuation events including timestamps and triggering conditions, and wireless communication events, for subsequent retrieval and analysis by utility operators or for regulatory compliance reporting. In certain embodiments, the apparatus comprises a diagnostic module configured to continuously monitor internal operational parameters including processor load, battery state of charge (504), solar panel output (502), and wireless link quality (306), detect internal faults or malfunctions, and automatically transmit diagnostic alerts to a remote monitoring system via wireless module 306.

In summary, the invention provides a comprehensive, non-invasive, and intelligent retrofit solution that transforms legacy manual reclosers into smart, remotely-controlled grid assets. By combining a universal mounting system (110) configurable for hanger-mount and standalone bracket-mount installations, a versatile actuator assembly (200) preserving manual operability, a rich sensor suite (308) with unique acoustic fault detection (316) and optional current sensing, standalone solar power (500), and a flexible hybrid edge-cloud control system with adaptive fault classification, the READI module addresses a critical gap in the market for cost-effective grid modernization and wildfire mitigation.

What is claimed is:

1. An externally mountable retrofit apparatus for remotely controlling an existing manually-operated electrical recloser installed on a utility pole, comprising:
(a) a two-piece mounting assembly configured to attach to the existing recloser or its associated mounting infrastructure without requiring disassembly of the recloser housing, wherein the associated mounting infrastructure includes at least one of a recloser hanger, a recloser body, a mounting bracket, cross-arm hardware, or other structural support member associated with the existing recloser, the mounting assembly being universally adjustable to accommodate reclosers of varying sizes, configurations, and mounting hardware;
(b) at least one actuator assembly selected from the group consisting of a magnetic servo, a closing coil, and a linear actuator, mechanically coupled via linkage to an external switch handle of the existing recloser to actuate opening and closing of the recloser while preserving the recloser's original manual operability;
(c) a wireless communication module providing at least one of Bluetooth communication and cellular communication for receiving remote control commands;
(d) a sensor suite comprising at least one environmental sensor configured to measure at least one of wind speed, relative humidity, and temperature;
(e) an acoustic sensor configured to continuously monitor ambient sound in a low-power sleep state for detection of fault conditions; and
(f) a processor executing control logic configured to automatically actuate the recloser based on sensor data, user-defined parameter thresholds, or regulatory compliance settings received remotely.

2. A method of retrofitting an existing manually-operated electrical recloser for remote and automated control, comprising:
(a) attaching a two-piece mounting assembly to the existing recloser or its associated mounting infrastructure without disassembling the recloser housing, wherein the associated mounting infrastructure comprises at least one of a recloser hanger, a recloser body, a mounting bracket, cross-arm hardware, or a structural support member associated with the recloser;
(b) mechanically coupling an actuator assembly to an external switch handle of the recloser via linkage;
(c) configuring sensor thresholds for at least one of wind speed, relative humidity, temperature, and acoustic fault detection;
(d) storing control parameters locally on the device or remotely in a cloud system, the parameters including at least one of user-defined thresholds and regulatory compliance settings; and
(e) automatically actuating the recloser when sensor readings meet or exceed the configured thresholds, or when an acoustic fault signature is detected by the acoustic sensor.

3. A distributed grid control system for coordinated three-phase recloser operation, comprising:
(a) a plurality of externally mountable retrofit apparatus units installed on a common utility pole or support structure, each unit comprising a two-piece mounting assembly attached to a respective single-phase manually-operated electrical recloser or its associated mounting infrastructure without disassembling the recloser housing, an actuator assembly mechanically coupled via linkage to the external switch handle of the respective recloser, a wireless communication module, a sensor suite, and a processor;
(b) a wireless communication link coupling the plurality of apparatus units such that a fault-triggered actuation event on a first unit causes coordinated actuation of the remaining units with minimal latency; and
(c) a user-configurable coordination mode selectable from at least independent operation mode, simultaneous trip mode.

4. The apparatus of claim 1, wherein the wireless communication module comprises both Bluetooth Low Energy (BLE) and cellular communication, and wherein a low-tier configuration provides Bluetooth-only communication for proximity-based field control.

5. The system of claim 3, wherein the wireless communication link comprises a dedicated communication interface for inter-module coordination enabling direct inter-unit communication between the plurality of apparatus units without requiring routing through a central server.

6. The apparatus of claim 1, further comprising a self-contained power system comprising a rechargeable battery and a solar panel associated with the apparatus and positioned to harvest solar energy, wherein the apparatus is fully standalone and requires no electrical connection to existing pole infrastructure, wherein the battery and solar panel are sized to support extended autonomous operation between charge cycles.

7. The apparatus of claim 1, wherein the acoustic sensor operates continuously in a low-power sleep state, monitoring for fault-indicative sounds including at least one of electrical arcing, mechanical stress impacts, overcurrent fault events, and wildlife or environmental contact, and wherein detection of a qualifying acoustic signature generates an interrupt signal that wakes the processor from a sleep state for fault analysis and recloser actuation or user notification.

8. The apparatus of claim 1, wherein the wireless communication module implements server-side rolling code authentication using time-sensitive single-use tokens, limiting control access to authorized personnel and preventing unauthorized access and replay attacks.

9. The apparatus of claim 1, wherein the control logic includes a wildfire compliance mode in which the apparatus operates with a user-configurable set of rules aligned with regulatory requirements and adaptable to local conditions including geographic region, pole environment, and historical weather patterns, and wherein the apparatus automatically places the recloser in a non-reclosing state when the measured wind speed exceeds the regulatory wind threshold while the measured relative humidity is simultaneously below the regulatory humidity threshold.

10. The apparatus of claim 1, wherein the control parameters, including sensor thresholds, compliance mode settings, and firmware, are remotely reprogrammable via the wireless communication module after field installation without requiring physical access to the apparatus.

11. The apparatus of claim 1, further comprising a camera configured to capture images or video and transmit visual monitoring data to a remote operator, enabling remote visual inspection of fault conditions and surrounding environmental hazards.

12. The apparatus of claim 1, wherein the mounting assembly comprises adjustable bracketing, bolting, and retention components configured to interface with recloser handles and mounting structures of varying physical configurations adapted to a range of installation contexts, and wherein the retention components provide supplemental attachment force accommodating varying handle geometries and materials without permanent modification.

13. The apparatus of claim 1, wherein the mounting assembly is configured to attach to a standalone three-phase recloser unit via adjustable bracketing that interfaces with the structural frame or body of the recloser assembly, or directly to the utility pole or cross-arm without requiring a dedicated recloser hanger.

14. The apparatus of claim 1, wherein the processor executes time-critical actuation rules locally at the apparatus without requiring network connectivity, and wherein complex sensor analysis and parameter updates are performed remotely and pushed to the apparatus via the wireless communication module.

15. The apparatus of claim 1, further comprising a data logging module configured to store in non-volatile memory at least historical sensor data, recloser actuation events, and communication events for subsequent retrieval and analysis.

16. The apparatus of claim 1, further comprising a diagnostic module configured to monitor internal operational parameters of the apparatus, detect internal faults or malfunctions, and transmit fault alerts to a remote monitoring system.

17. The apparatus of claim 1, wherein the wireless communication module and processor are further configured to interface with a Supervisory Control and Data Acquisition (SCADA) system using at least one of DNP3, IEC 61850, and Modbus protocols, providing status updates and receiving control commands.

18. The method of claim 2, further comprising the step of remotely updating firmware of the apparatus via the wireless communication module after field installation, without requiring physical access to the apparatus.

19. The apparatus of claim 1, further comprising a location-determination capability configured to associate the apparatus with a geographic position, wherein the geographic position is determinable by at least one of: a GPS module integrated into the apparatus, a software-assigned coordinate entered by an authorized operator, or coordinates derived from a third-party geographic information system, enabling asset tracking and location-based automation rules.

20. The apparatus of claim 1, optionally comprising a non-contact current sensor configured to measure AC load current flowing through the existing recloser, wherein the current data is analyzed by the processor to detect overloads, fault signatures, abnormal operational states, line loss conditions, and parasitic load conditions.

21. The apparatus of claim 1, wherein the processor executes an adaptive fault classification algorithm configured to distinguish between fault conditions requiring actuation and benign environmental events based on multi-sensor data correlation, and wherein the adaptive fault classification algorithm is updateable remotely via the wireless communication module to incorporate updated classification parameters derived from field data collected across a plurality of deployed apparatus units, without requiring physical access to the apparatus.

22. The apparatus of claim 1, further comprising a maintenance lockout mode wherein the processor (302) prevents actuation of the recloser during a user-initiated lockout period, the maintenance lockout mode being activatable and deactivatable via the wireless communication module (306), and wherein the maintenance lockout mode overrides all automatic actuation triggers for the duration of the lockout period.
